(19) United States
(12) Patent Application Publication
(10) Pub. No.: US 2024/0184341 A1
(43) Pub. Date: Jun. 6, 2024

(54) KEYBOARD DEVICE

(71) Applicant: Primax Electronics Ltd., Taipei (TW)

(72) Inventors: Shao-Wei Yang, Taipei (TW); Chin-Lung Chan, Taipei (TW); Yi-Hsien Lin, Taipei (TW)

(21) Appl. No.: 18/106,377

(22) Filed: Feb. 6, 2023

(30) Foreign Application Priority Data
Dec. 2, 2022 (TW) 111146463

(51) Int. Cl. G06F 1/16

(52) U.S. Cl. CPC G06F 1/1667

(57) ABSTRACT

A keyboard device for an electronic device includes a keyboard main body and a protection plate member. The protection plate member is pivotally coupled to the keyboard main body. Consequently, the keyboard main body is covered by the protection plate member, or a first angle is formed between the protection plate member and the keyboard main body. The protection plate member includes a first plate and a second plate. The keyboard main body is pivotally coupled to a first end of the first plate. The second plate is pivotally coupled to a second end of the first plate. After the protection plate member is rotated relative to the keyboard main body and the first angle is formed between the protection plate member and the keyboard main body, the protection plate member is further adjusted to a selected usage mode.

### FIELD OF THE INVENTION

The present invention relates to an input device, and more particularly to a keyboard device.

### BACKGROUND OF THE INVENTION

Generally, the common input device of a computer system includes for example a mouse device, a keyboard device or a trackball device. Via the keyboard device, the user may input characters and symbols into the computer system. As a consequence, most users and most manufacturers pay much attention to the development of keyboard devices.

Hereinafter, the structure and function of a conventional keyboard device will be illustrated with reference to FIG. 1. FIG. 1 is a schematic top view illustrating the outward appearance of a conventional keyboard device.

As shown in FIG. 1, the keyboard device 1 comprises plural keys. The plural keys are installed on a surface of the keyboard device 1. These keys are classified into some types, e.g., ordinary keys 10, numeric keys 11 and function keys 12. When one of the keys is depressed by the user's finger, the keyboard device 1 generates a corresponding key signal to a computer, and thus the computer executes a corresponding function. For example, when an ordinary key 10 is depressed, a corresponding English letter or symbol is inputted into the computer. When a numeric key 11 is depressed, a corresponding number is inputted into the computer. In addition, the function keys 12 (F1˜F12) can be programmed to provide various quick access functions.

With increasing development of science and technology, a tablet computer has been introduced into the market. The tablet computer has a small-sized shape as an LCD screen. Generally, the display screen of the tablet computer is a touch screen. Via the touch screen, the user may input instruction to the tablet computer to control operations of the tablet computer. Generally, when the user intends to input a character or a symbol into the tablet computer, an on-screen keyboard is enabled and shown on the touch screen of the tablet computer. The on-screen keyboard is a virtual keyboard simulating the real keyboard device. By touching an icon of the on-screen keyboard, a corresponding character or symbol is inputted into the tablet computer. In other words, characters or symbols can be directly inputted into the tablet computer without the need of connecting the tablet computer to any external keyboard device.

Since the tablet computer has a small-sized shape and no external keyboard device is needed, the tablet computer is easily carried. However, the use of the tablet computer still has some drawbacks. For example, the use of the touch screen to input characters or symbols becomes hindrance for most users who are familiar with the common personal computers or notebook computers. Consequently, in many circumstances, an external keyboard device having functions and structures similar to the keyboard device as shown in FIG. 1 is connected to the tablet computer. In addition, the tablet computer is placed and supported on a prop stand (e.g., a bookshelf). That is, the tablet computer is usually regarded as a common display screen, and the external keyboard device is used for inputting characters or symbols. Generally, the external keyboard device is connected with the tablet computer through a universal serial bus (USB) connection.

Although the use of the external keyboard device may facilitate the user to operate the tablet computer in the usual practice, there are still some drawbacks. For example, the external keyboard device and the tablet computer need to be simultaneously carried. If the external keyboard device is not simultaneously carried with the tablet computer, the user has no choice but to input characters or symbols through the on-screen keyboard on the touch screen in the non-usual practice. As mentioned above, if the user wants to operate the tablet computer in the usual practice, it is necessary to additionally carry the external keyboard device. If the user does not want to additionally carry the external keyboard device, the user needs to directly input characters or symbols through the on-screen keyboard on the touch screen. The above two approaches, however, are not user-friendly.

Therefore, it is important to provide an improved keyboard device in order to overcome the drawbacks of the conventional technologies.

### SUMMARY OF THE INVENTION

An object of the present invention provides a keyboard device. The keyboard device can be connected with an electronic device. In addition, the keyboard device can be operated in various usage modes to support the electronic device.

The other objects and advantages of the present invention will be understood from the disclosed technical features.

In accordance with an aspect of the present invention, a keyboard device for an electronic device is provided. The keyboard device includes a keyboard main body and a protection plate member. The protection plate member is pivotally coupled to the keyboard main body. The protection plate member is rotatable relative to the keyboard main body. Consequently, the keyboard main body is covered by the protection plate member, or a first angle is formed between the protection plate member and the keyboard main body. The protection plate member includes a first plate and a second plate. The keyboard main body is pivotally coupled to a first end of the first plate. The second plate is pivotally coupled to a second end of the first plate. The first end and the second end of the first plate are opposed to each other. The second plate is rotatable relative to the first plate. After the protection plate member is rotated relative to the keyboard main body and the first angle is formed between the protection plate member and the keyboard main body, the protection plate member is further adjusted to a selected usage mode of plural usage modes, and the electronic device is supported by the first plate or the second plate of the protection plate member in the selected usage mode.

In an embodiment, when the selected usage mode of the protection plate member is a first usage mode, an included angle between the first plate of the protection plate member and the keyboard main body is the first angle, and the second plate of the protection plate member is rotated relative to the keyboard main body. Consequently, a second angle is formed between the second plate of the protection plate member and the keyboard main body. In the first usage mode, the electronic device is supported by the second plate of the protection plate member, the first angle is larger than 0 degree and smaller than 90 degrees, and the second angle is larger than 90 degrees and smaller than 180 degrees.

In an embodiment, when the selected usage mode of the protection plate member is a second usage mode, the first plate of the protection plate member is rotated relative to the keyboard main body in a direction away from the keyboard main body such that an included angle between the first plate of the protection plate member and the keyboard main body is changed from the first angle to a second angle, and the second plate of the protection plate member is rotated relative to the first plate such that an end of the second plate is contacted with a reference plane where the keyboard main body is placed. In the second usage mode, the electronic device is supported by the first plate of the protection plate member, the first angle is larger than 0 degree and smaller than 90 degrees, and the second angle is larger than 90 degrees and smaller than 180 degrees.

In an embodiment, the keyboard device further includes a first pivotal coupling mechanism and a second pivotal coupling mechanism. The first pivotal coupling mechanism is pivotally coupled to a junction between the first plate and the second plate of the protection plate member. The second pivotal coupling mechanism is pivotally coupled to a junction between the first plate of the protection plate member and the keyboard main body.

In an embodiment, a torsional force of the first pivotal coupling mechanism and a torsional force of the second pivotal coupling mechanism are different.

In an embodiment, the first pivotal coupling mechanism is a single-axis shaft structure.

In an embodiment, the second pivotal coupling mechanism includes a housing, a first dual-axis shaft structure and a second dual-axis shaft structure. The first dual-axis shaft structure and the second dual-axis shaft structure are installed in the casing. The first dual-axis shaft structure includes a first upper shaft unit and a first lower shaft unit. The second dual-axis shaft structure includes a second upper shaft unit and a second lower shaft unit. Each of the first upper shaft unit and the second upper shaft unit includes a first rotary shaft. Each of the first lower shaft unit and the second lower shaft unit includes a second rotary shaft. The first rotary shaft of the first upper shaft unit and the first rotary shaft of the second upper shaft unit are respectively connected with two opposite sides of the first plate of the protection plate member. The second rotary shaft of the first lower shaft unit and the second rotary shaft of the second lower shaft unit are respectively connected with two opposite sides of the keyboard main body.

In an embodiment, the first upper shaft unit further includes a first cam member and a first cam engaging part, and the second upper shaft unit further includes a second cam member and a second cam engaging part. The first rotary shaft of the first upper shaft unit is penetrated through the first cam member and the first cam engaging part. The first rotary shaft of the second upper shaft unit is penetrated through the second cam member and the second cam engaging part. The first cam member includes a first convex structure. The second cam member includes a second convex structure. The first cam engaging part includes a first concave structure. The second cam engaging part includes a second concave structure. While the protection plate member is rotated relative to the keyboard main body through the first rotary shaft of the first upper shaft unit and the first rotary shaft of the second upper shaft unit, the first cam member and the second cam member are correspondingly rotated with the first rotary shaft of the first upper shaft unit and the first rotary shaft of the second upper shaft unit, and the first convex structure and the second convex structure are correspondingly rotated with the first cam member and the second cam member. Wen an included angle between the protection plate member and the keyboard main body is adjusted to the first angle, the first convex structure of the first cam member is engaged with the first concave structure of the first cam engaging part, and the second convex structure of the second cam member is engaged with the second concave structure of the second cam engaging part.

In an embodiment, the second pivotal coupling mechanism further includes a pivotal rod and an elastic sheet. The pivotal rod is connected between the first rotary shaft of the first upper shaft unit and the first rotary shaft of the second upper shaft unit. The pivotal rod includes a protrusion structure. While the protection plate member is rotated relative to the keyboard main body and an included angle between the protection plate member and the keyboard main body is adjusted to the first angle, the pivotal rod is correspondingly rotated with the first rotary shaft of the first upper shaft unit and the first rotary shaft of the second upper shaft unit. While the pivotal rod is rotated, the protrusion structure is correspondingly rotated to compress the elastic sheet, so that the elastic sheet is subjected to deformation.

In an embodiment, the first plate of the protection plate member has a first magnetic attraction surface, and the second plate of the protection plate member has a second magnetic attraction surface. The first plate is magnetically attachable on the backside of the electronic device through the first magnetic attraction surface. The second plate is magnetically attachable on the backside of the electronic device through the second magnetic attraction surface.

In an embodiment, the keyboard device further includes a locking structure, and the locking structure is installed on the first plate of the protection plate member. When the electronic device is supported by the first plate of the protection plate member, the electronic device is locked by the locking structure.

In an embodiment, the keyboard device further includes a magnetic attraction assembly, and the magnetic attraction assembly is arranged between the first plate of the protection plate member and the electronic device. The magnetic attraction assembly includes a first magnet group and a second magnet group. The first magnet group is installed in or installed on the first plate of the protection plate member. The second magnet group is installed in or installed on the electronic device. The first magnet group includes plural first magnetic pole parts and plural second magnetic pole parts. The second magnet group includes plural third magnetic pole parts and plural fourth magnetic pole parts. The plural first magnetic pole parts and the plural second magnetic pole parts are alternately arranged. The plural third magnetic pole parts and the plural fourth magnetic pole parts are alternately arranged. Each of the plural first magnetic pole parts and each of the plural second magnetic pole parts have unlike poles. Each of the plural third magnetic pole parts and each of the plural fourth magnetic pole parts have unlike poles. The plural first magnetic pole parts and the plural fourth magnetic pole parts have like poles. The plural second magnetic pole parts and the third magnetic pole parts have like poles.

In an embodiment, the first magnet group of the magnetic attraction assembly is movable between a first position and a second position in response to an external force. When the first magnet group is in the first position, the plural first magnetic pole parts are respectively aligned with the plural third magnetic pole parts, and the plural second magnetic pole parts are respectively aligned with the plural fourth magnetic pole parts. When the first magnet group is in the second position, some of the plural first magnetic pole parts are respectively aligned with the corresponding fourth magnetic pole parts, and some of the plural second magnetic pole parts are respectively aligned with the corresponding third magnetic pole parts.

In an embodiment, the magnetic attraction assembly further includes a linking mechanism. The linking mechanism is installed in or installed on the first plate of the protection plate member. The linking mechanism drives a movement of the first magnet group between the first position and the second position. The linking mechanism includes a pushing part, a first linking part and a second linking part. The first linking part is pivotally coupled between the pushing part and the second linking part. The first magnet group is installed on the second linking part. While the pushing part is pushed in response to the external force and moved in a first direction, the first linking part is pushed by the pushing part. While the first linking part is moved in the first direction, the second linking part is correspondingly moved in a second direction opposite to the first direction, so that the first magnet group is moved from the first position to the second position.

From the above descriptions, the present invention provides the keyboard device. In the keyboard device, the torsional force of the first pivotal coupling mechanism and the torsional force of the second pivotal coupling mechanism are different. Consequently, the protection plate member can be switched between various usage modes (e.g., a suspension mode, a reading mode, a notebook mode and a drawing mode). In addition, the protection plate member can be rotated relative to the keyboard main body to achieve the effect of the stepless adjustment between 0 degree and 360 degrees. Moreover, in the magnetic attraction assembly, the first magnetic pole parts and the second magnetic pole parts of the first magnet group are alternately arranged, and the third magnetic pole parts and the fourth magnetic pole parts of the second magnet group are alternately arranged. Consequently, the protection plate member can be switched to the suspension mode in a more intuitive manner. Moreover, the structure is specially designed. During the operations, a sound is generated to prompt the user to switch the protection plate member to a different usage mode. Consequently, the use flexibility of the keyboard device is largely enhanced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outward appearance of a conventional keyboard device;

FIG. 2 is a schematic perspective view illustrating the outward appearance of a keyboard device according to an embodiment of the present invention, in which the keyboard device is in an unfolded state;

FIG. 3 is a schematic perspective view illustrating the outward appearance of the keyboard device as shown in FIG. 2, in which the keyboard device is in a folded state;

FIG. 4 is a schematic side view illustrating the keyboard device as shown in FIG. 2;

FIG. 5 is a schematic exploded view illustrating a portion of a second pivotal coupling mechanism of the keyboard device as shown in FIG. 2;

FIG. 6 is a schematic perspective view illustrating the enlarged portion of a dual-axis shaft structure of the keyboard device as shown in FIG. 5;

FIG. 7 is a schematic side view illustrating the keyboard device as shown in FIG. 2, in which the protection plate member is in a first usage mode;

FIG. 8 is a schematic side view illustrating the keyboard device as shown in FIG. 2, in which the protection plate member is in a second usage mode;

FIG. 9 is a schematic side view illustrating the keyboard device as shown in FIG. 2, in which the protection plate member is in a third usage mode;

FIG. 10 is a schematic side view illustrating the keyboard device as shown in FIG. 2, in which the protection plate member is in a fourth usage mode;

FIG. 11 is a schematic perspective view illustrating the outward appearance of a keyboard device according to another embodiment of the present invention, in which the keyboard device is in an unfolded state;

FIG. 12 is a schematic exploded view illustrating a portion of a second pivotal coupling mechanism of the keyboard device as shown in FIG. 11;

FIG. 13 is a schematic perspective view illustrating a portion of a magnetic attraction assembly of the keyboard device as shown in FIG. 11; and

FIGS. 14A and 14B schematically illustrate the operations of the magnetic attraction assembly of the keyboard device as shown in FIG. 11.

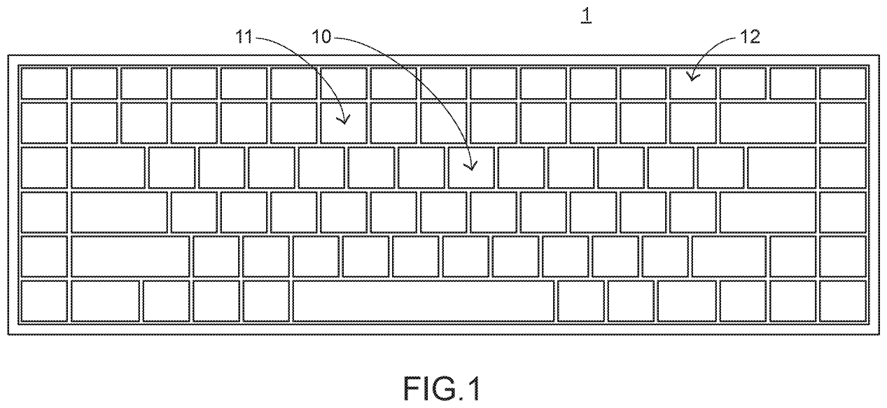

### DETAILED DESCRIPTION OF THE PREFERRED EMBODIMENT

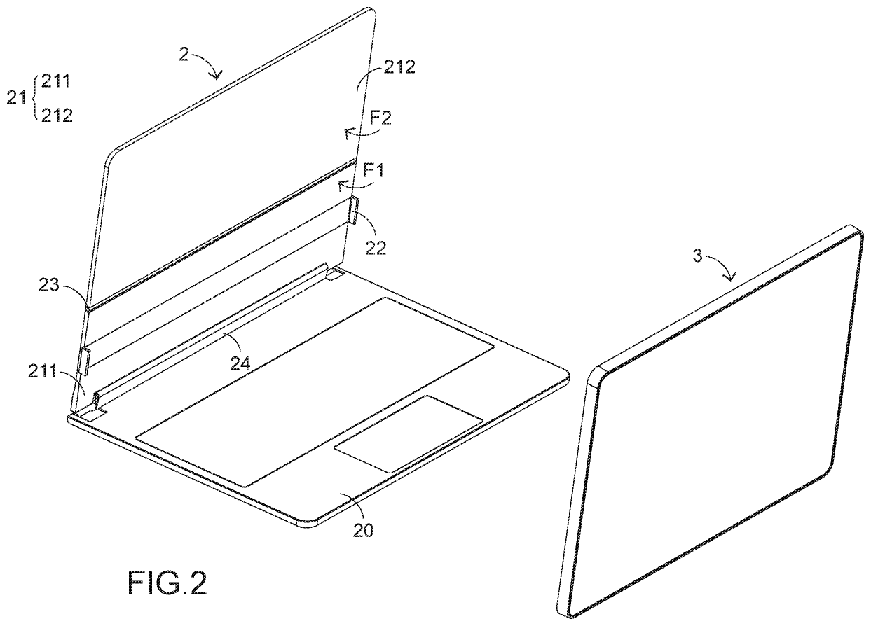

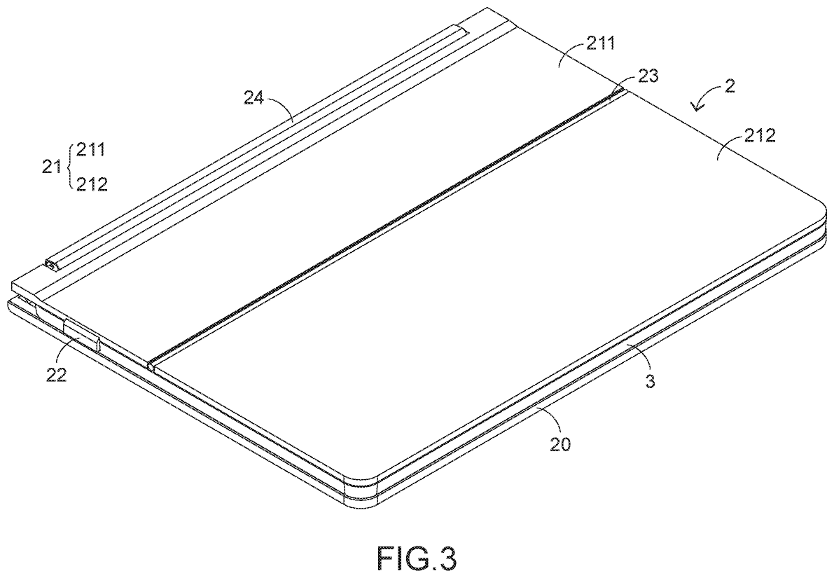

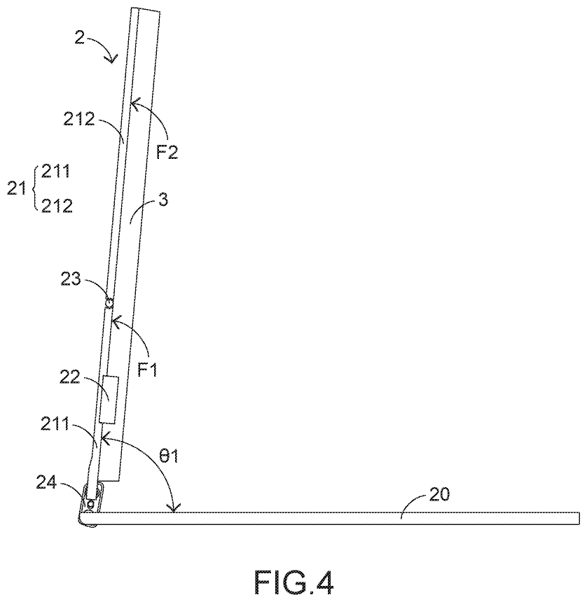

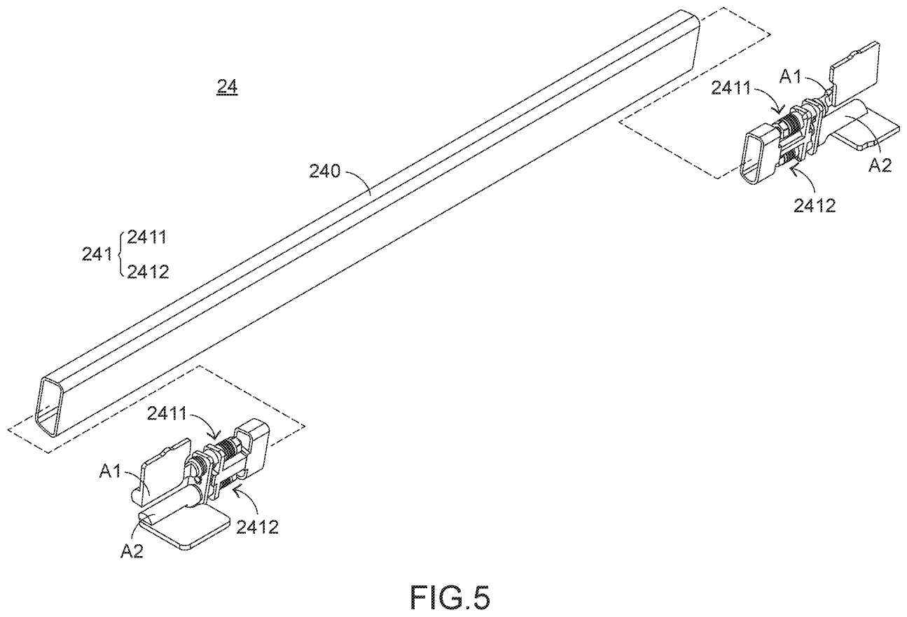

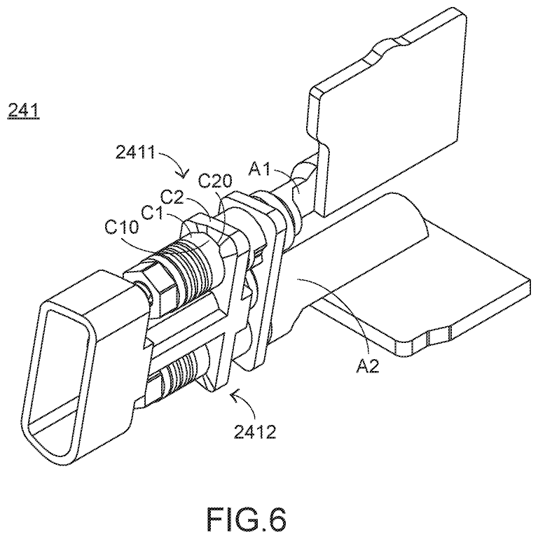

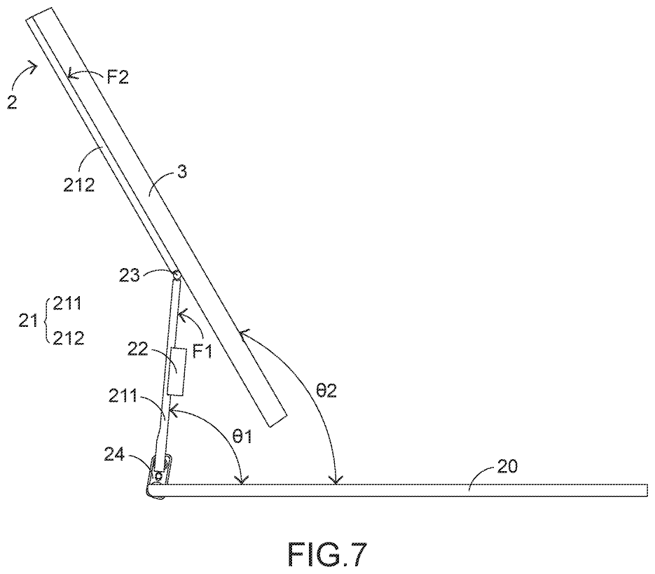

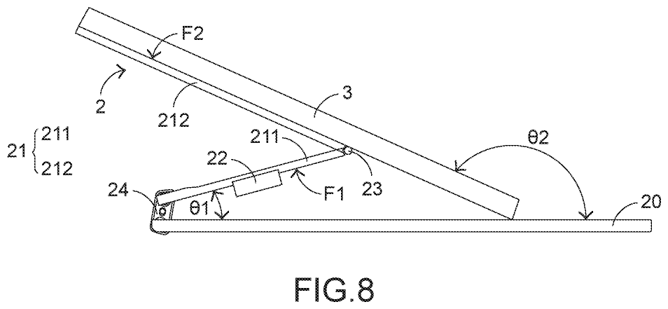

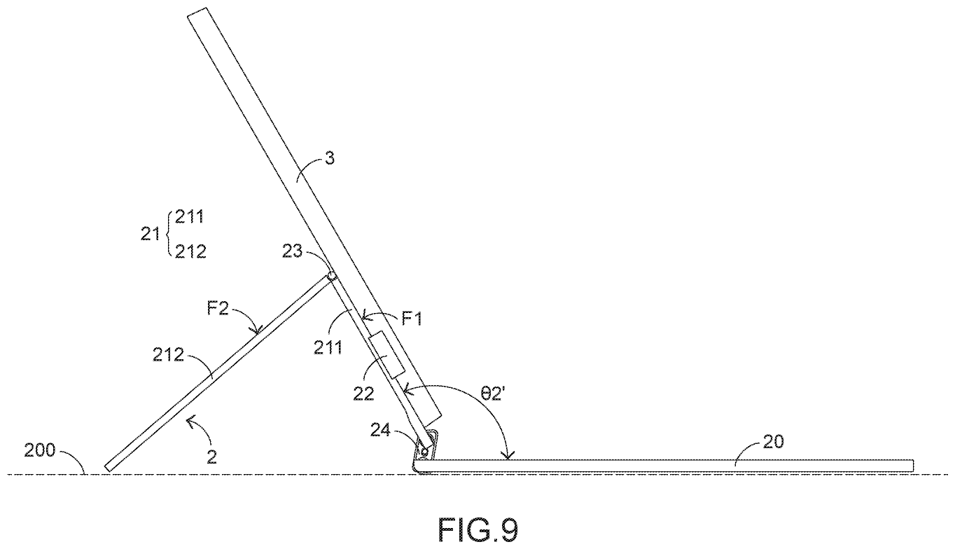

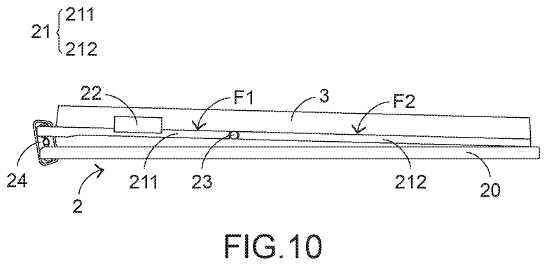

Please refer to FIGS. 2 to 10. FIG. 2 is a schematic perspective view illustrating the outward appearance of a keyboard device according to an embodiment of the present invention, in which the keyboard device is in an unfolded state. FIG. 3 is a schematic perspective view illustrating the outward appearance of the keyboard device as shown in FIG. 2, in which the keyboard device is in a folded state. FIG. 4 is a schematic side view illustrating the keyboard device as shown in FIG. 2. FIG. 5 is a schematic exploded view illustrating a portion of a second pivotal coupling mechanism of the keyboard device as shown in FIG. 2. FIG. 6 is a schematic perspective view illustrating the enlarged portion of a dual-axis shaft structure of the keyboard device as shown in FIG. 5. FIG. 7 is a schematic side view illustrating the keyboard device as shown in FIG. 2, in which the protection plate member is in a first usage mode. FIG. 8 is a schematic side view illustrating the keyboard device as shown in FIG. 2, in which the protection plate member is in a second usage mode. FIG. 9 is a schematic side view illustrating the keyboard device as shown in FIG. 2, in which the protection plate member is in a third usage mode. FIG. 10 is a schematic side view illustrating the keyboard device as shown in FIG. 2, in which the protection plate member is in a fourth usage mode.

Please refer to FIGS. 2, 3 and 4. In an embodiment, the keyboard device 2 is applied to an electronic device 3. The keyboard device 2 can be connected with the electronic device 3. For example, the keyboard device 2 is connected with the electronic device 3 in a Bluetooth transmission manner or any other appropriate wireless transmission manner. Consequently, the user can operate the keyboard device 2 to control the electronic device 3. In this embodiment, the electronic device 3 is a tablet computer. It is noted that the example of the electronic device 3 is not restricted. For example, in another embodiment, the electronic device 3 is a smart phone.

Please refer to FIGS. 2, 3 and 4 again. In an embodiment, the keyboard device 2 comprises a keyboard main body 20 and a protection plate member 21. The protection plate member 21 is pivotally coupled to the keyboard main body 20. The protection plate member 21 is rotatable relative to the keyboard main body 20. Consequently, in an unfolded state as shown in FIG. 2, a first angle θ1 can be formed between the protection plate member 21 and the keyboard main body 20. In the unfolded state, the protection plate member 21 can be selectively switched between various usage modes. Consequently, the electronic device 3 is supported by the protection plate member 21 in the selected usage mode. Moreover, when the protection plate member 21 is rotated relative to the keyboard main body 20 to cover the keyboard main body 20, the keyboard device 2 is in a folded state as shown in FIG. 3. In the folded state, the electronic device 3 is stored in the region between the protection plate member 21 and the keyboard main body 20. Consequently, the electronic device 3 can be effectively protected.

The structure of the keyboard device 2 will be described in more details as follows.

Please refer to FIGS. 2, 3 and 4 again. In an embodiment, the protection plate member 21 comprises a first plate 211 and a second plate 212. The keyboard main body 20 is pivotally coupled to a first end of the first plate 211. The second plate 212 is pivotally coupled to a second end of the first plate 211. The first end and the second end of the first plate 211 are opposed to each other. After the protection plate member 21 is rotated relative to the keyboard main body 20 and the first angle θ1 is formed between the protection plate member 21 and the keyboard main body 20, the second plate 212 of the protection plate member 21 is rotatable relative to the first plate 211, or the first plate 211 of the protection plate member 21 is rotatable relative to the keyboard main body 20. Consequently, the protection plate member 21 can be switched between various usage modes, and the electronic device 3 can be supported by the first plate 211 or the second plate 212 in the selected usage mode.

Please refer to FIGS. 2, 3 and 4 again. In the protection plate member 21, the first plate 211 has a first magnetic attraction surface F1, and the second plate 212 has a second magnetic attraction surface F2. In an embodiment, each of the first magnetic attraction surface F1 of the first plate 211 and the second magnetic attraction surface F2 of the second plate 212 has a magnet (not shown), and the backside of the electronic device 3 is made of the magnetic material. Alternatively, the backside of the electronic device 3 has at least one magnet (not shown), and the first magnetic attraction surface F1 of the first plate 211 and the second magnetic attraction surface F2 of the second plate 212 are made of magnetic material. When the electronic device 3 is placed on the protection plate member 21, at least one of the first magnetic attraction surface F1 of the first plate 211 and the second magnetic attraction surface F2 of the second plate 212 and the backside of the electronic device 3 are magnetically attached on each other. Consequently, the electronic device 3 can be securely fixed on the protection plate member 21.

Please refer to FIGS. 2, 3 and 4 again. In an embodiment, the keyboard device 2 further comprises a locking structure 22. The locking structure 22 is installed on the first plate 211 of the protection plate member 21. When the protection plate member 21 is in a specific usage mode and the electronic device 3 is supported by the first plate 211, the locking structure 22 can be used to lock the electronic device 3.

Please refer to FIGS. 2, 3, 4, 5 and 6. In an embodiment, the keyboard device 2 further comprises a first pivotal coupling mechanism 23 and a second pivotal coupling mechanism 24. The first pivotal coupling mechanism 23 is pivotally coupled to the junction between the first plate 211 and the second plate 212 of the protection plate member 21. The second pivotal coupling mechanism 24 is pivotally coupled to the junction between the first plate 211 of the protection plate member 21 and the keyboard main body 20. In this embodiment, the torsional force of the first pivotal coupling mechanism 23 is larger than the torsional force of the second pivotal coupling mechanism 24.

Please refer to FIGS. 2, 3, 4, 5 and 6 again. In an embodiment, the first pivotal coupling mechanism 23 is a single-axis shaft structure, and the second pivotal coupling mechanism 24 comprises a housing 240 and two dual-axis shaft structures 241. The two dual-axis shaft structures 241 are installed in the housing 240. Each dual-axis shaft structure 241 comprises an upper shaft unit 2411 and a lower shaft unit 2412. The upper shaft unit 2411 comprises a first rotary shaft A1. The lower shaft unit 2412 comprises a second rotary shaft A2. In the left dual-axis shaft structure 241, the upper shaft unit 2411 is connected with the left side of the first plate 211 of the protection plate member 21 through the first rotary shaft A1, and the lower shaft unit 2412 is connected with the left side of the keyboard main body 20 through the second rotary shaft A2. Similarly, in the right dual-axis shaft structure 241, the upper shaft unit 2411 is connected with the right side of the first plate 211 of the protection plate member 21 through the first rotary shaft A1, and the lower shaft unit 2412 is connected with the right side of the keyboard main body 20 through the second rotary shaft A2.

In an embodiment, each upper shaft unit 2411 comprises a cam member C1 and a cam engaging part C2. The first rotary shaft A1 is penetrated through the cam member C1 and the cam engaging part C2. The cam member C1 comprises a convex structure C10. The cam engaging part C2 comprises a concave structure C20. While the protection plate member 21 is rotated relative to the keyboard main body 20 through the first rotary shaft A1 of the upper shaft unit 2411, the cam member C1 is correspondingly rotated with the first rotary shaft A1. Moreover, while the cam member C1 is rotated, the convex structure C10 is correspondingly rotated. When the included angle between the protection plate member 21 and the keyboard main body 20 is adjusted to the first angle θ1, the convex structure C10 of the cam member C1 is engaged with the concave structure C20 of the cam engaging part C2. Consequently, the protection plate member 21 is fixed at the position where the included angle between the protection plate member 21 and the keyboard main body 20 is the first angle θ1.

In this embodiment, the protection plate member 21 is fixed at the position where the included angle between the protection plate member 21 and the keyboard main body 20 is approximately 90 degrees. It is noted that the included angle is not restricted. For example, in another embodiment, the relative positions between the convex structure of the cam member C1 and the concave structure C20 of the cam engaging part C2 are changed. Consequently, the protection plate member 21 can be fixed at the position where the included angle between the protection plate member 21 and the keyboard main body 20 is larger than 0 degree and smaller than 90 degrees.

The methods of switching the keyboard device 2 between various usage modes will be described as follows.

In FIG. 7, a protection plate member 21 of the keyboard device 2 in a first usage mode is shown. Please also refer to FIGS. 2 to 6. After the protection plate member 21 is rotated relative to the keyboard main body 20 through the second pivotal coupling mechanism 24 (i.e., the two opposite dual-axis shaft structures 241) and the first angle θ1 is formed between the protection plate member 21 and the keyboard main body 20, the keyboard device 2 is switched from the folded state as shown in FIG. 3 to the unfolded state as shown in FIG. 4. Meanwhile, in each upper shaft unit 2411, the convex structure C10 of the cam member C1 is locked in the concave structure C20 of the corresponding cam engaging part C2. Consequently, the protection plate member 21 is fixed at the position where the first angle θ1 between the protection plate member 21 and the keyboard main body 20 is formed. Then, the second plate 212 of the protection plate member 21 is rotated relative to the first plate 211 through the first pivotal coupling mechanism 23, and thus a second angle θ2 is formed between the second plate 212 and the keyboard main body 20. In other words, the included angle formed between the display screen of the electronic device 3 and the keyboard main body 20 is also the second angle θ2. Meanwhile, the included angle between the first plate 211 and the keyboard main body 20 is the first angle θ1, and the included angle between the second plate 212 and the keyboard main body 20 is the second angle θ2. That is, the relationship between the first plate 211 and the second plate 212 is switched from a coplanar state to a non-coplanar state. Consequently, the first plate 211 is detached from the backside of the electronic device 3, and the electronic device 3 is detached from the locking structure 22. Under this circumstance, only the second plate 212 and the backside of the electronic device 3 are magnetically attached on each other. In this usage mode, it seems that the electronic device 3 is suspended over the keyboard main body 20. This usage mode may be referred as a suspension mode.

In the above embodiment, the first angle θ1 is larger than 0 degree and smaller than 90 degrees, and the second angle θ2 is larger than 90 degrees and smaller than 180 degrees. That is, in the usage mode as shown in FIG. 7, the first plate 211 of the protection plate member 21 is rotatable relative to the keyboard device 20 at an angle larger than 0 degree and smaller than 90 degrees, and the second plate 212 of the protection plate 21 is rotatable relative to the keyboard device 20 at an angle larger than 90 degrees and smaller than 180 degrees.

Please refer to the situation shown in FIG. 7 again. Then, the first plate 211 is rotated in a direction toward the keyboard main body 20. Consequently, the first angle θ1 between the first plate 211 and the keyboard main body 20 is decreased. Then, the second plate 212 is rotated in a direction away from the keyboard main body 20. Consequently, the second angle θ2 between the second plate 212 and the keyboard main body 20 is increased. Meanwhile, as shown in FIG. 8, the protection plate member 21 of the keyboard device 2 is in the second usage mode. In this usage mode, the texts shown on the electronic device 3 can be read by the user more conveniently. In other words, this usage mode may be referred as a reading mode.

In FIG. 9, a protection plate member 21 of the keyboard device 2 in a third usage mode is shown. Please also refer to FIGS. 2 to 6. After the protection plate member 21 is rotated relative to the keyboard main body 20 through the second pivotal coupling mechanism 24 and the first angle θ1 is formed between the protection plate member 21 and the keyboard main body 20, the convex structure C10 of the cam member C1 in each upper shaft unit 2411 is locked in the concave structure C20 of the corresponding cam engaging part C2. Consequently, the protection plate member 21 is locked at the position where the first angle θ1 between the keyboard main body 20 is formed (i.e., in the unfolded state as shown in FIG. 4). Then, the first plate 211 of the protection plate member 21 is rotated relative to the keyboard main body 20 in a direction away from the keyboard device 20 through the second pivotal coupling mechanism 24, and thus the included angle between the first plate 211 and the keyboard main body 20 is switched from the first angle θ1 to a second angle θ2′. Then, the second plate 212 of the protection plate member 21 is rotated relative to the first plate 211 through the first pivotal coupling mechanism 23, and thus the second plate 212 is detached from the backside of the electronic device 3. Under this circumstance, only the first plate 211 and the backside of the electronic device 3 are magnetically attached on each other. In addition, an end of the second plate 212 is contacted with a reference plane 200 (e.g., a table surface) where the keyboard main body 20 is placed. This usage mode is like the mode of using a notebook computer. That is, the relative positions between the electronic device 3 and the keyboard main body 20 are identical to the relative positions between the display screen of a notebook computer and the keyboard device. In this usage mode, the electronic device 3 is locked by the locking structure 22 of the first plate 211. Consequently, the electronic device 3 will not fall down from the first plate 211.

In the above embodiment, the first angle θ1 is larger than 0 degree and smaller than 90 degrees, and the second angle θ2′ is larger than 90 degrees and smaller than 180 degrees. For example, in the usage mode as shown in FIG. 9, the first plate 211 of the protection plate member 21 is firstly rotated relative to the keyboard device 20 at an angle larger than 0 degree and smaller than 90 degrees. After the included angle between the first plate 211 and the keyboard body 20 is fixed at the angle largen than 0 degree and smaller than 90 degrees, the first plate 211 is rotated in the direction away from the keyboard device 20 at an angle larger than 90 degrees and smaller than 180 degrees.

Moreover, after the included angle between the first plate 211 and the keyboard main body 20 is switched from the first angle θ1 to the second angle θ2′, the convex structure C10 of the cam member C1 in each upper shaft unit 2411 is disengaged from the concave structure C20 of the corresponding cam engaging part C2. Since the second pivotal coupling mechanism 24 provides the smaller torsional force and the second pivotal coupling mechanism 24 is unable to provide a sufficient supporting force to support the first plate 211, the first plate 211 is unable to effectively support the electronic device 3. Under this circumstance, the first pivotal coupling mechanism 23 with the larger torsional force is used to provide the sufficient supporting force to the second plate 212. After the second plate 212 is contacted with the reference plane 200, the second plate 212 provides the sufficient support force to support the first plate 211. Consequently, the electronic device 3 can be effectively supported.

Furthermore, the protection plate 21 is rotatable relative to the keyboard body 20 to the backside of the keyboard body 20 through the second pivotal coupling mechanism 24. That is, after the protection plate 21 in the folded state as shown in FIG. 3 is rotated relative to the keyboard body 20 by 360 degrees, the protection plate 21 is rotated to the backside of the keyboard body 20. Meanwhile, as shown in FIG. 10, the protection plate member 21 of the keyboard device 2 is in the fourth usage mode. In this usage mode, a drawing software interface shown on the electronic device 3 can be used to draw by the user more conveniently. For example, after the protection plate 21 in the folded state is rotated relative to the keyboard body 20 by 180 degrees through the upper shaft units 2411 of the dual-axis shaft structures 241 of the second pivotal coupling mechanism 24, the protection plate 21 is continuously rotated relative to the keyboard body 20 by 180 degrees through the lower shaft units 2412 of the dual-axis shaft structures 241 of the second pivotal coupling mechanism 24. Consequently, the protection plate 21 is rotated to the backside of the keyboard body 20.

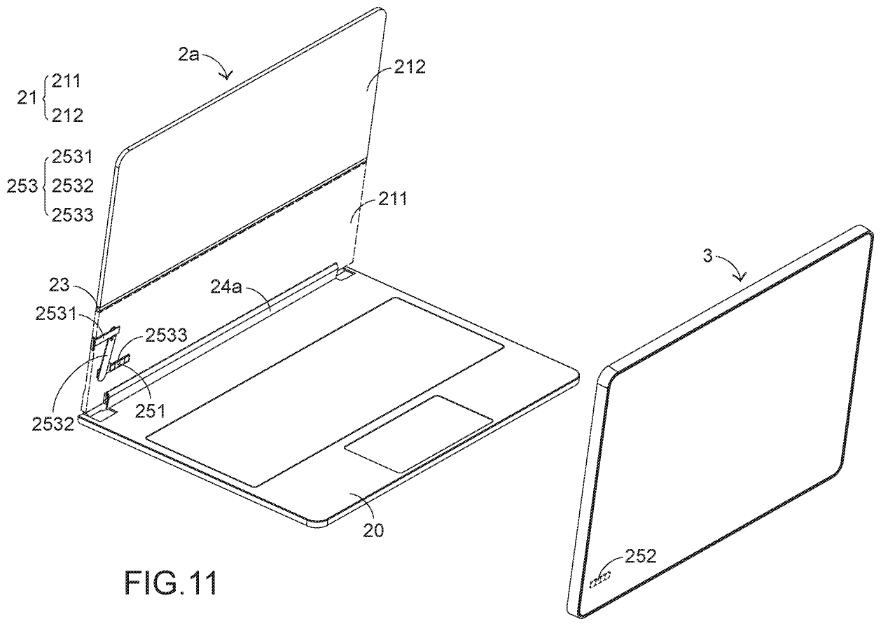

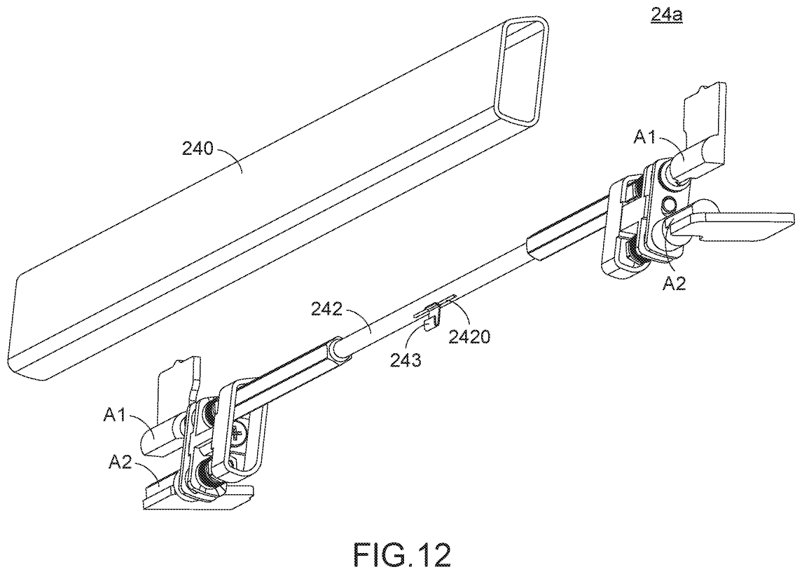

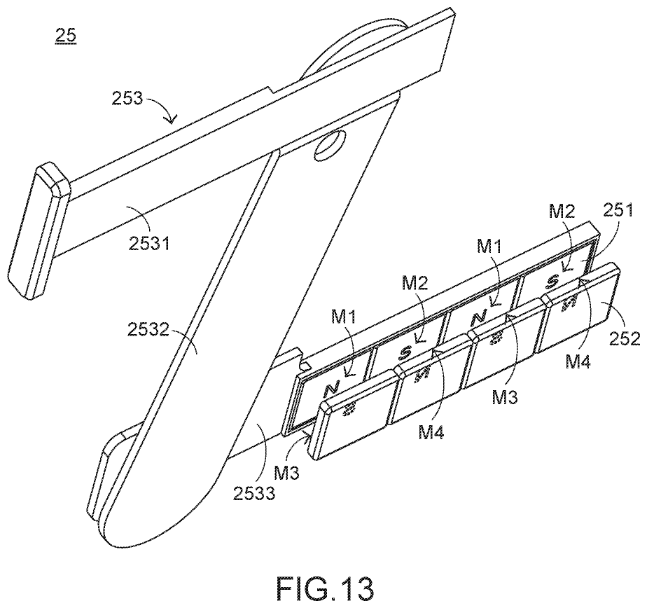

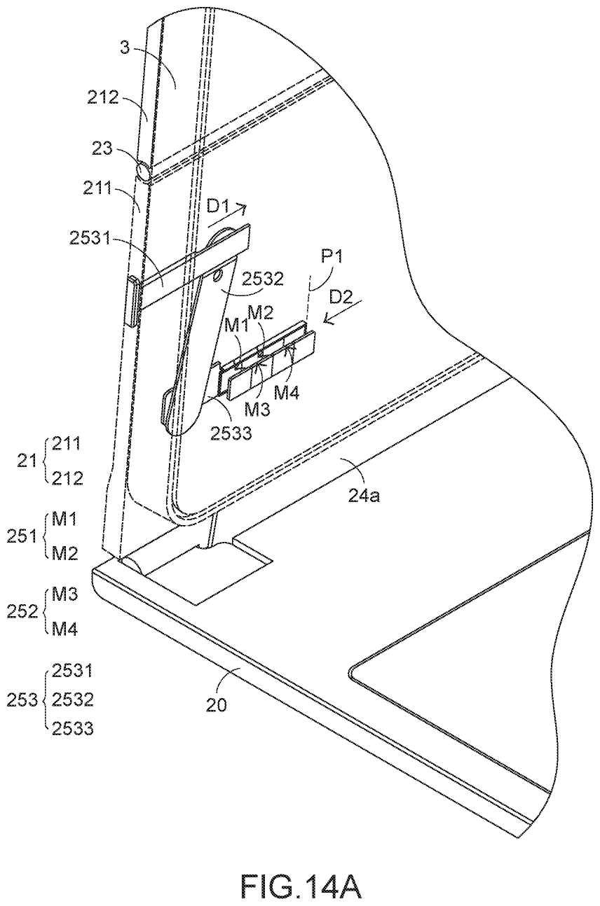

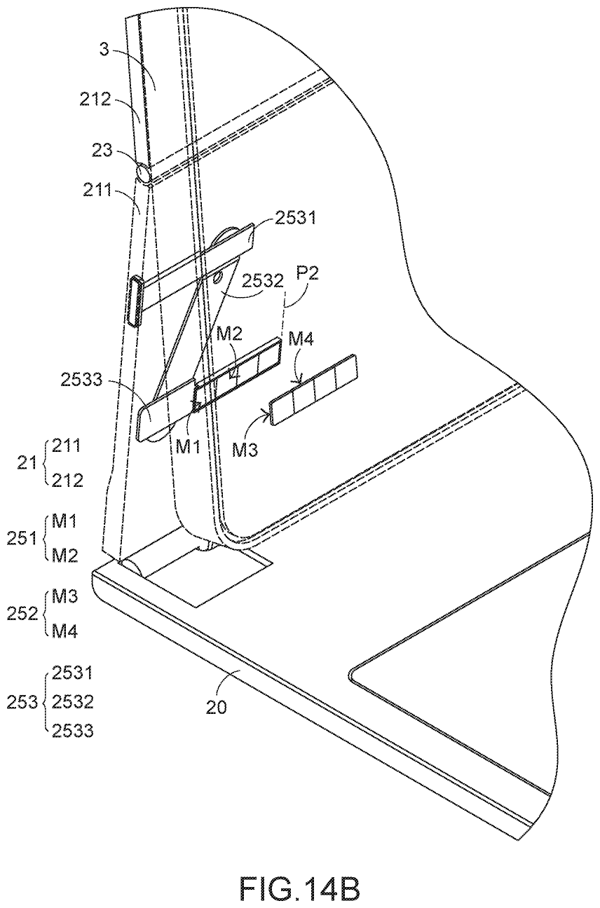

Please refer FIGS. 11, 12, 13, 14A and 14B. FIG. 11 is a schematic perspective view illustrating the outward appearance of a keyboard device according to another embodiment of the present invention, in which the keyboard device is in an unfolded state. FIG. 12 is a schematic exploded view illustrating a portion of a second pivotal coupling mechanism of the keyboard device as shown in FIG. 11. FIG. 13 is a schematic perspective view illustrating a portion of a magnetic attraction assembly of the keyboard device as shown in FIG. 11. FIGS. 14A and 14B schematically illustrate the operations of the magnetic attraction assembly of the keyboard device as shown in FIG. 11. The structures and functions of the keyboard device 2a of this embodiment are similar to those of the keyboard device 2 as shown in FIGS. 2 to 10. In comparison with the keyboard device 2, the second pivotal coupling mechanism 24a in the keyboard device 2a of this embodiment further comprises a pivotal rod 242 and an elastic sheet 243. The torsional force of the second pivotal coupling mechanism 24a is larger than the torsional force of the first pivotal coupling mechanism 23. Moreover, the keyboard device 2a of this embodiment further comprises a magnetic attraction assembly 25.

As shown in FIGS. 11 and 12, the pivotal rod 242 of the second pivotal coupling mechanism 24a is connected between the first rotary shafts A1 of the two upper shaft units 2411. In addition, the pivotal rod 242 comprises a protrusion structure 2420.

While the protection plate member 21 is rotated relative to the keyboard main body 20 through the first rotary shafts A1 of the two upper shaft units 2411 and the included angle between the protection plate member 21 and the keyboard main body 20 is adjusted to the first angle θ1, the pivotal rod 242 is correspondingly rotated with the first rotary shafts A1 of the two upper shaft units 2411. In an embodiment, a first end of the elastic sheet 243 is located beside the protrusion structure 2420, and a second end of the elastic sheet 243 is fixed on the housing 240. Consequently, while the pivotal rod 242 is rotated, the protrusion structure 2420 of the pivotal rod 242 is correspondingly rotated to compress the elastic sheet 243. Consequently, the elastic sheet 243 is subjected to deformation. It is noted that the fixed position of the elastic sheet 243 is not restricted to the housing 240.

Please refer to FIGS. 11, 13, 14A and 14B. In an embodiment, the magnetic attraction assembly 25 comprises a first magnet group 251 and a second magnet group 252. The first magnet group 251 is installed in or installed on the first plate 211 of the protection plate member 21. The second magnet group 252 is installed in or installed on the electronic device 3. The first magnet group 251 comprises plural first magnetic pole parts M1 and plural second magnetic pole parts M2. The plural first magnetic pole parts M1 and the plural second magnetic pole parts M2 are alternately arranged. The second magnet group 252 comprises plural third magnetic pole parts M3 and plural fourth magnetic pole parts M4. The plural third magnetic pole parts M3 and the plural fourth magnetic pole parts M4 are alternately arranged.

The first magnetic pole parts M1 and the second magnetic pole parts M2 have unlike poles, and the third magnetic pole parts M3 and the fourth magnetic pole parts M4 have unlike poles. Moreover, the first magnetic pole parts M1 and the fourth magnetic pole parts M4 have like poles, and the second magnetic pole parts M2 and the third magnetic pole parts M3 have like poles. For example, the first magnetic pole parts M1 and the fourth magnetic pole parts M4 are N poles, and the second magnetic pole parts M2 and the third magnetic pole parts M3 are S poles.

In this embodiment, the first plate 211 of the protection plate member 21 and the backside of the electronic device 3 are magnetically attached on each other through the magnetic attraction assembly 25. However, like the above embodiment, the second plate 212 of the protection plate member 21 and the backside of the electronic device 3 are magnetically attached on each other through the second magnetic attraction surface F2. Due to this structural design, the electronic device 3 can be securely fixed on the protection plate member 21.

Especially, the first magnet group 251 of the magnetic attraction assembly 25 is movable between a first position P1 and a second position P2 in response to an external force. In the situation of FIG. 14A, the first magnet group 251 is in the first position P1. Under this circumstance, the plural first magnetic pole parts M1 of the first magnet group 251 are respectively aligned with the plural third magnetic pole parts M3 of the second magnet group 252, and the plural second magnetic pole parts M2 of the first magnet group 251 are respectively aligned with the plural fourth magnetic pole parts M4 of the second magnet group 252. In the situation of FIG. 14B, the first magnet group 251 is moved relative to the second magnet group 252 in response to the external force, and the first magnet group 251 is moved from the first position P1 to the second position P2. Under this circumstance, some of the plural first magnetic pole parts M1 of the first magnet group 251 are respectively aligned with the corresponding fourth magnetic pole parts M4 of the second magnet group 252, and some of the plural second magnetic pole parts M2 of the first magnet group 251 are respectively aligned with the corresponding third magnetic pole parts M3 of the second magnet group 252.

In an embodiment, the magnetic attraction assembly 25 further comprises a linking mechanism 253. The linking mechanism 253 is installed in or installed on the first plate 211 of the protection plate member 21. The linking mechanism 253 is used to drive the movement of the first magnet group 251 between the first position P1 and the second position P2. In an embodiment, the linking mechanism 253 comprises a pushing part 2531, a first linking part 2532 and a second linking part 2533.

The pushing part 2531 of the linking mechanism 253 is partially exposed outside the first plate 211 of the protection plate member 21. The first linking part 2532 of the linking mechanism 253 is pivotally coupled between the pushing part 2531 and the second linking part 2533. Moreover, the first magnet group 251 is installed on the second linking part 2533. While the pushing part 2531 of the linking mechanism 253 is pushed in response to an external force and moved in a first direction D1, the first linking part 2532 is pushed by the pushing part 2531. As the first linking part 2532 is moved, the second linking part 2533 is correspondingly moved in a second direction D2. The first direction D1 and the second direction D2 are opposite to each other. Consequently, the first magnet group 251 is moved from the first position P1 to the second position P2.

The operations of the keyboard device 2a of this embodiment are similar to those of the keyboard device 2 as shown in FIGS. 2 to 10. That is, the usage mode of the keyboard device 2a can be switched between the usage modes as shown in FIGS. 7, 8, 9 and 10. For example, while the protection plate member 21 is rotated relative to the keyboard main body 20 through the second pivotal coupling mechanism 24 (i.e., the two opposed dual-axis shaft structures 241) and the included angle between the protection plate member 21 and the keyboard main body 20 is adjusted to the first angle θ1 (i.e., the folded state as shown in FIG. 3 is switched to the unfolded state as shown in FIG. 4), the pivotal rod 242 is correspondingly rotated with the first rotary shafts A1 of the two upper shaft units 2411. Moreover, while the pivotal rod 242 is rotated, the protrusion structure 2420 is correspondingly rotated to compress the elastic sheet 243. Consequently, the elastic sheet 243 is subjected to deformation. While the elastic sheet 243 is restored from the deformation state, a sound is generated to prompt the user to enable the magnetic attraction assembly 25 in the current status. That is, the pushing part 2531 of the linking mechanism 253 is pushed in the first direction D1, and the second linking part 2533 is correspondingly moved in the second direction D2 opposite to the first direction D1. Consequently, the first magnet group 251 is moved from the first position P1 to the second position P2.

When the first magnet group 251 is in the second position P2, some of the plural first magnetic pole parts M1 (e.g., N poles) of the first magnet group 251 are respectively aligned with the corresponding fourth magnetic pole parts M4 (e.g., N poles) of the second magnet group 252, and some of the plural second magnetic pole parts M2 (e.g., S poles) of the first magnet group 251 are respectively aligned with the corresponding third magnetic pole parts M3 (e.g., S poles) of the second magnet group 252. According to the principle “Like poles of magnets repel each other”, the first magnetic pole parts M1 (e.g., N poles) and the corresponding fourth magnetic pole parts M4 (e.g., N poles) of the second magnet group 252 repel each other, and the second magnetic pole parts M2 (e.g., S poles) of the first magnet group 251 and the corresponding third magnetic pole parts M3 (e.g., S poles) repel each other. In response to the magnetic repulsive force, the first plate 211 of the protection plate member 21 is detached from the backside of the electronic device 3. In this situation, the magnetic repulsive force is larger than the torsional force of the first pivotal coupling mechanism 23. Consequently, while the first plate 211 of the protection plate member 21 is detached from the backside of the electronic device 3 in response to the magnetic repulsive force, the second plate 212 of the protection plate member 21 is rotated relative to the first plate 211 through the first pivotal coupling mechanism 23. In this way, the second angle θ2 is formed between the second plate 212 and the keyboard main body 20, and only the second plate 212 and the backside of the electronic device 3 are magnetically attached on each other. In this usage mode, it seems that the electronic device 3 is suspended over the keyboard main body 20. That is, this usage mode is similar to the usage mode of FIG. 7.

In order to switch the keyboard device 2a to the usage mode as shown in FIG. 9 (i.e., the usage mode like a notebook computer), the following procedures will be performed. Firstly, the protection plate member 21 is rotated relative to the keyboard main body 20 through the second pivotal coupling mechanism 24a, and thus the first angle θ1 is formed between the protection plate member 21 and the keyboard main body 20. Then, the first plate 211 of the protection plate member 21 is rotated relative to the keyboard main body 20 in the direction away from the keyboard device 20 through the second pivotal coupling mechanism 24a. Consequently, the included angle between the first plate 211 and the keyboard main body 20 is switched from the first angle θ1 to the second angle θ2′. Then, the second plate 212 of the protection plate member 21 is rotated relative to the first plate 211 through the first pivotal coupling mechanism 23, and thus the second plate 212 is detached from the backside of the electronic device 3. As mentioned above, the torsional force of the second pivotal coupling mechanism 24a is larger than the torsional force of the first pivotal coupling mechanism 23. Due to the larger torsional force of the second pivotal coupling mechanism 24a, the sufficient supporting force is provided to support second plate 212. Consequently, the keyboard device 2a is switched to the usage mode as shown in FIG. 9 (i.e., the usage mode like a notebook computer). That is, the relative positions between the electronic device 3 and the keyboard main body 20 are identical to the relative positions between the display screen of the notebook computer and the keyboard device.

From the above descriptions, the present invention provides the keyboard device. In the keyboard device, the torsional force of the first pivotal coupling mechanism and the torsional force of the second pivotal coupling mechanism are different. Consequently, the protection plate member can be switched between various usage modes (e.g., a suspension mode, a reading mode, a notebook mode and a drawing mode). In addition, the protection plate member can be rotated relative to the keyboard main body to achieve the effect of the stepless adjustment between 0 degree and 360 degrees. Moreover, in the magnetic attraction assembly, the first magnetic pole parts and the second magnetic pole parts of the first magnet group are alternately arranged, and the third magnetic pole parts and the fourth magnetic pole parts of the second magnet group are alternately arranged. Consequently, the protection plate member can be switched to the suspension mode in a more intuitive manner. Moreover, the structure is specially designed. During the operations, a sound is generated to prompt the user to switch the protection plate member to a different usage mode. Consequently, the use flexibility of the keyboard device is largely enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A keyboard device for an electronic device, the keyboard device comprising:
a keyboard main body; and
a protection plate member pivotally coupled to the keyboard main body, wherein the protection plate member is rotatable relative to the keyboard main body, so that the keyboard main body is covered by the protection plate member or a first angle is formed between the protection plate member and the keyboard main body, wherein the protection plate member comprises a first plate and a second plate, the keyboard main body is pivotally coupled to a first end of the first plate, the second plate is pivotally coupled to a second end of the first plate, the first end and the second end of the first plate are opposed to each other, and the second plate is rotatable relative to the first plate,
wherein after the protection plate member is rotated relative to the keyboard main body and the first angle is formed between the protection plate member and the keyboard main body, the protection plate member is further adjusted to a selected usage mode of plural usage modes, and the electronic device is supported by the first plate or the second plate of the protection plate member in the selected usage mode.

2. The keyboard device according to claim 1, wherein when the selected usage mode of the protection plate member is a first usage mode, an included angle between the first plate of the protection plate member and the keyboard main body is the first angle, and the second plate of the protection plate member is rotated relative to the keyboard main body, so that a second angle is formed between the second plate of the protection plate member and the keyboard main body, wherein in the first usage mode, the electronic device is supported by the second plate of the protection plate member, the first angle is larger than 0 degree and smaller than 90 degrees, and the second angle is larger than 90 degrees and smaller than 180 degrees.

3. The keyboard device according to claim 1, wherein when the selected usage mode of the protection plate member is a second usage mode, the first plate of the protection plate member is rotated relative to the keyboard main body in a direction away from the keyboard main body such that an included angle between the first plate of the protection plate member and the keyboard main body is changed from the first angle to a second angle, and the second plate of the protection plate member is rotated relative to the first plate such that an end of the second plate is contacted with a reference plane where the keyboard main body is placed, wherein in the second usage mode, the electronic device is supported by the first plate of the protection plate member, the first angle is larger than 0 degree and smaller than 90 degrees, and the second angle is larger than 90 degrees and smaller than 180 degrees.

4. The keyboard device according to claim 1, wherein the keyboard device further comprises a first pivotal coupling mechanism and a second pivotal coupling mechanism, wherein the first pivotal coupling mechanism is pivotally coupled to a junction between the first plate and the second plate of the protection plate member, and the second pivotal coupling mechanism is pivotally coupled to a junction between the first plate of the protection plate member and the keyboard main body.

5. The keyboard device according to claim 4, wherein a torsional force of the first pivotal coupling mechanism and a torsional force of the second pivotal coupling mechanism are different.

6. The keyboard device according to claim 4, wherein the first pivotal coupling mechanism is a single-axis shaft structure.

7. The keyboard device according to claim 4, wherein the second pivotal coupling mechanism comprises a housing, a first dual-axis shaft structure and a second dual-axis shaft structure, wherein the first dual-axis shaft structure and the second dual-axis shaft structure are installed in the casing, the first dual-axis shaft structure comprises a first upper shaft unit and a first lower shaft unit, the second dual-axis shaft structure comprises a second upper shaft unit and a second lower shaft unit, each of the first upper shaft unit and the second upper shaft unit comprises a first rotary shaft, and each of the first lower shaft unit and the second lower shaft unit comprises a second rotary shaft, wherein the first rotary shaft of the first upper shaft unit and the first rotary shaft of the second upper shaft unit are respectively connected with two opposite sides of the first plate of the protection plate member, and the second rotary shaft of the first lower shaft unit and the second rotary shaft of the second lower shaft unit are respectively connected with two opposite sides of the keyboard main body.

8. The keyboard device according to claim 7, wherein the first upper shaft unit further comprises a first cam member and a first cam engaging part, and the second upper shaft unit further comprises a second cam member and a second cam engaging part, wherein the first rotary shaft of the first upper shaft unit is penetrated through the first cam member and the first cam engaging part, and the first rotary shaft of the second upper shaft unit is penetrated through the second cam member and the second cam engaging part, wherein the first cam member comprises a first convex structure, the second cam member comprises a second convex structure, the first cam engaging part comprises a first concave structure, and the second cam engaging part comprises a second concave structure, wherein while the protection plate member is rotated relative to the keyboard main body through the first rotary shaft of the first upper shaft unit and the first rotary shaft of the second upper shaft unit, the first cam member and the second cam member are correspondingly rotated with the first rotary shaft of the first upper shaft unit and the first rotary shaft of the second upper shaft unit, and the first convex structure and the second convex structure are correspondingly rotated with the first cam member and the second cam member, wherein when an included angle between the protection plate member and the keyboard main body is adjusted to the first angle, the first convex structure of the first cam member is engaged with the first concave structure of the first cam engaging part, and the second convex structure of the second cam member is engaged with the second concave structure of the second cam engaging part.

9. The keyboard device according to claim 7, wherein the second pivotal coupling mechanism further comprises a pivotal rod and an elastic sheet, wherein the pivotal rod is connected between the first rotary shaft of the first upper shaft unit and the first rotary shaft of the second upper shaft unit, and the pivotal rod comprises a protrusion structure, wherein while the protection plate member is rotated relative to the keyboard main body and an included angle between the protection plate member and the keyboard main body is adjusted to the first angle, the pivotal rod is correspondingly rotated with the first rotary shaft of the first upper shaft unit and the first rotary shaft of the second upper shaft unit, wherein while the pivotal rod is rotated, the protrusion structure is correspondingly rotated to compress the elastic sheet, so that the elastic sheet is subjected to deformation.

10. The keyboard device according to claim 1, wherein the first plate of the protection plate member has a first magnetic attraction surface, and the second plate of the protection plate member has a second magnetic attraction surface, wherein the first plate is magnetically attachable on the backside of the electronic device through the first magnetic attraction surface, and the second plate is magnetically attachable on the backside of the electronic device through the second magnetic attraction surface.

11. The keyboard device according to claim 1, wherein the keyboard device further comprises a locking structure, and the locking structure is installed on the first plate of the protection plate member, wherein when the electronic device is supported by the first plate of the protection plate member, the electronic device is locked by the locking structure.

12. The keyboard device according to claim 1, wherein the keyboard device further comprises a magnetic attraction assembly, and the magnetic attraction assembly is arranged between the first plate of the protection plate member and the electronic device, wherein the magnetic attraction assembly comprises a first magnet group and a second magnet group, the first magnet group is installed in or installed on the first plate of the protection plate member, the second magnet group is installed in or installed on the electronic device, the first magnet group comprises plural first magnetic pole parts and plural second magnetic pole parts, and the second magnet group comprises plural third magnetic pole parts and plural fourth magnetic pole parts, wherein the plural first magnetic pole parts and the plural second magnetic pole parts are alternately arranged, and the plural third magnetic pole parts and the plural fourth magnetic pole parts are alternately arranged, wherein each of the plural first magnetic pole parts and each of the plural second magnetic pole parts have unlike poles, each of the plural third magnetic pole parts and each of the plural fourth magnetic pole parts have unlike poles, the plural first magnetic pole parts and the plural fourth magnetic pole parts have like poles, and the plural second magnetic pole parts and the third magnetic pole parts have like poles.

13. The keyboard device according to claim 12, wherein the first magnet group of the magnetic attraction assembly is movable between a first position and a second position in response to an external force, wherein when the first magnet group is in the first position, the plural first magnetic pole parts are respectively aligned with the plural third magnetic pole parts, and the plural second magnetic pole parts are respectively aligned with the plural fourth magnetic pole parts, wherein when the first magnet group is in the second position, some of the plural first magnetic pole parts are respectively aligned with the corresponding fourth magnetic pole parts, and some of the plural second magnetic pole parts are respectively aligned with the corresponding third magnetic pole parts.

14. The keyboard device according to claim 13, wherein the magnetic attraction assembly further comprises a linking mechanism, wherein the linking mechanism is installed in or installed on the first plate of the protection plate member, the linking mechanism drives a movement of the first magnet group between the first position and the second position, and the linking mechanism comprises a pushing part, a first linking part and a second linking part, wherein the first linking part is pivotally coupled between the pushing part and the second linking part, and the first magnet group is installed on the second linking part, wherein while the pushing part is pushed in response to the external force and moved in a first direction, the first linking part is pushed by the pushing part, wherein while the first linking part is moved in the first direction, the second linking part is correspondingly moved in a second direction opposite to the first direction, so that the first magnet group is moved from the first position to the second position.
